(19) United States
(12) Patent Application Publication
(10) Pub. No.: US 2006/0182075 A1
(43) Pub. Date: Aug. 17, 2006

(54) Network and method for configuring a network

(75) Inventors: Marcus Brunner, Heidelberg (DE); Lars Eggert, Heidelberg (DE); Kai Zimmerman, Heidelberg (DE); Juergen Quittek, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/353,087

(22) Filed: Feb. 14, 2006

(30) Foreign Application Priority Data
Feb. 14, 2005 (DE) 102005006872.3

(51) Int. Cl. H04Q 7/24

(52) U.S. Cl. 370/338

(57) ABSTRACT

Network, in particular a wireless network according to IEEE standard 802.11 or the like, wherein the network comprises of an arbitrary number of access points and a multitude of preferably mobile client stations is—regarding a functionally reliable organization process of the network, that in particular scales also for larger networks—designed and further developed with easy means in such a way that the access points communicate with each other and auto-configure themselves in a decentralized manner by exchanging information.

### BACKGROUND OF THE INVENTION

1. Field of the Invention

The present invention concerns a network and, in particular, a wireless network according to IEEE standard 802.11, IEEE standard 802.16 or the like, wherein the network comprises of an arbitrary number of access points as well as a multitude of preferably mobile client stations. Furthermore, the invention concerns a method for configuring a network.

2. Description of the Related Art

Networks as mentioned above as well as methods for configuring such networks are known in practice. Especially in the context of the development and the increasing use of the IEEE standard 802.11, the set-up and the configuration of wireless networks (wireless local area networks, WLANs) gain more and more importance.

Based on locally acquired feedback and/or performance information—such as, for example, radio transmission power—individual access points in modern networks control only a few of their parameters locally, since the majority of the parameters have to be coordinated among a multitude of access points. The parameters that have to be coordinated are therefore not controlled locally within a group of involved access points, but often have to be configured individually and manually at each access point of the network.

The configuration of (wireless) networks requires—depending on the size of the network—possibly the coordination of a large number of access points, whose individual parameters, settings and functionalities have to be adjusted to each other according to the concrete network environment. In modern networks, this task is performed—as already mentioned—either manually or automatically by a central management system that is located within the wireless network and performs a management function. In general, with such central management systems different system parameters are configured, such as, for example, appropriate transmission frequencies or radio transmission power.

Especially for the installation of larger wireless networks, several automated methods for network configuration have been developed during the last years. The goal of all these developments is some sort of plug-and-play solution, which configures all system parameters automatically, without the need for manual intervention. The existing solutions in this area are based on an algorithm that helps to establish a network-wide consensus regarding individual configuration decisions. The algorithms operate as functions provided by a central network management system and make their decisions based on information acquired either at the access points to be configured or entered manually by an administrator.

FIG. 1 shows schematically four access points AP 1 to AP 4 in a wireless network. The circles around the access points indicate the corresponding coverage areas. According to this, access points AP 1 and AP 2 as well as access points AP 3 and AP 4 show respectively overlapping coverage areas. For the configuration of the network, it is an essential goal that those access points that cover overlapping areas use different channels. This is important in order to avoid disturbing interferences.

According to the scenario depicted in FIG. 1, AP 1 and AP 2 have such significant overlapping areas that they can communicate directly with each other. Consequently, they are able to detect the common coverage area by themselves. As a reaction to this detection, AP 1 and AP 2 can mutually agree on different transmission channels.

The situation is different for AP 3 and AP 4, whose overlapping area is smaller and which therefore cannot communicate directly with each other. Nevertheless, AP 3 and AP 4 should also use different channels, because otherwise disturbing interferences can occur between client stations that are located within the overlapping area. Without using network clients that are located near or within the overlapping area, there is no possibility to automatically detect an overlap as shown in the case of AP 3 and AP 4.

The methods for automated network configuration as known from the state of the art have two disadvantages. First, it is disadvantageous that the known methods require a central management system by which the needed capabilities for configuring a network are provided. Hence, in addition to the access points, (at least) one more device is needed which results in a complicated and cost-intensive configuration process. Additionally, scalability is more limited than necessary, because local problems that impact only a (small) group of access points or possibly only one access point cannot be solved locally.

### SUMMARY OF THE INVENTION

Hence, the present invention is based on the task to design and further develop a network as well as a method for configuring a network such that a reliable organization process of the network is achieved by easy means and that also scales, especially to larger networks.

According to the invention, the task mentioned above is solved by a network showing the characteristics of patent claim 1. According to this, such a network is characterized in that the access points of the network communicate with each other and configure themselves in a decentralized way by exchanging information.

The problem mentioned above is furthermore solved by the method for configuring a network according to claim 19. According to this, the access points of the network communicate with each other and configure themselves in a decentralized way by exchanging information.

According to the invention, it has first been recognized that a central control of the configuration process is extremely complicated and in particular not very practicable in larger networks. Furthermore, according to the invention, it has been recognized that it is possible to dispense with a specific central management system if the access points of the network communicate with each other and auto-configure themselves in a decentralized way by exchanging information. In other words, the access point exchange messages and agree on a configuration based on the exchanged information. Due to the decentralized configuration process as according to the invention, scalability is also significantly increased, because locally occurring problems which impact only a part of the access points of the network can be solved locally.

Regarding a possibly comprehensive organization of the network, the auto-configuration of the access points comprises in an advantageous way of a multitude of different facets. The auto-configuration can refer in particular to the assignment of channels as well as to setting the signal strength and security parameters. Furthermore, the determination of those client stations for which access is permitted can be incorporated into the configuration process.

Regarding a secure and efficient communication between the access points, a protocol can be provided that supports the exchange of measured environmental parameters. These measured environmental parameters can in particular be information about the usage of channels by access points of the network or by other networks. The protocol can furthermore be designed in such a way that it supports the access points with regard to configuration decisions, i.e., with regard to the mutual agreement on specific configurations.

In a concrete embodiment, the mutual communication of the access points is realized via a network interconnecting the access points. In particular, for this purpose, a local area network (LAN) has been proven to be advantageous. The physical realization of this interconnection network can be either wired or wireless. The wired solution can, for example, be an Ethernet, whereas the access points in case of a wireless network can be equipped with two antennas. The access to the network for client stations can be realized via one antenna whereas the other antenna can be used for communication with the rest of the access points of the network.

Regarding the continuity of the network configuration during operation of the network, it can be provided that the information exchanged between the access points is used in a continuous manner in order to automatically adapt the network to changed conditions within the network.

Regarding a dynamical optimization of the network configuration within an environment with changing parameters it is provided that, in addition to the observations and measurements of the involved access points, information of client stations is sensed and provided to the access points. By doing so, the auto-configuration decisions that have to be taken by the access points can be based on a broader and sounder information base. The information provided by the client stations can, in particular, refer to interferences between the access points of the network, to interferences with other wireless networks and/or the distribution of the signal strength within the covered area. It has turned out that only by including a very limited subset of client stations, configuration problems can be avoided and results can significantly be improved.

When the access points receive information from the client stations, it can furthermore be provided that they validate the received data regarding their security and consistency properties and that they perform additional checks.

In an especially advantageous way, the input contributed by the client stations is directly provided to the access points, because by doing so, a local self-organization based on this input is allowed. Such an approach is in contrast to the so-called client-assisted approaches, where clients provide their input to a management system or an access router, which act a central entity.

In an especially preferred embodiment, the information provided by the client stations is used to detect a local network topology. In other words, the information of the access points is used to find out which other access points are in the neighborhood. In an especially advantageous way, and for this purpose, the client stations have equipment for position sensing, preferably GPS (Global Positioning System). Based on the information provided by the client stations, the access points and groups of access points consequently could create geographical maps of the areas they cover.

In a particularly advantageous way, within the network, specific additional stations can be provided, which will be in the following referred to as “measurement stations”. Complementing the “ordinary” client stations, these measurement stations can provide additional input to the access points in order to support the auto-configuration process. In contrast to the client stations, the measurement stations, which are specifically optimized for this purpose, have the advantage that—regarding time and space requirements—they can be used accordingly in a flexible way. In case of client stations, however, it can occur that they have disabled their services and are consequently not able to provide information to the access points or that they try with malicious intention to damage the network by sending manipulated information.

In a further advantageous manner, the measurement stations can be designed to be mobile so they can explore the area covered by them dynamically. The mobility can be provided either manually by an administrator or by robots that move the measurement stations autonomously. The mobile measurement stations can map, for example, channel allocations, interferences or signal strengths throughout their coverage area and, in addition, they can also show sources of interferences or disturbances. Furthermore, it can be provided that the access points instruct the measurement stations, for example, regarding their movement direction and/or regarding specific targets within the network.

By doing so, a measurement station could for example be moved as near as possible to another station or an access point which is disturbing the operation of the network. Alternatively or additionally, the mobile measurement stations can be equipped with a function that moves the station autonomously to points of particular interest, for example, to sources of disturbance or to areas that are only insufficiently covered by the access points.

Now, there are several options of how to design and to further develop the teaching of the present invention in an advantageous way. For this purpose, it must be referred to the claims subordinate to claim 1 and 19 on the one hand and to the following explanation of a preferred example of an embodiment of the network and the method for configuring a network according to the invention together with the figure on the other hand. In connection with the explanation of the preferred example of an embodiment and the figure, generally preferred designs and further developments of the teaching will also be explained.

### BRIEF DESCRIPTION OF THE DRAWINGS

FIG. 1 is a schematic diagram showing a wireless network according to the state of the art; and

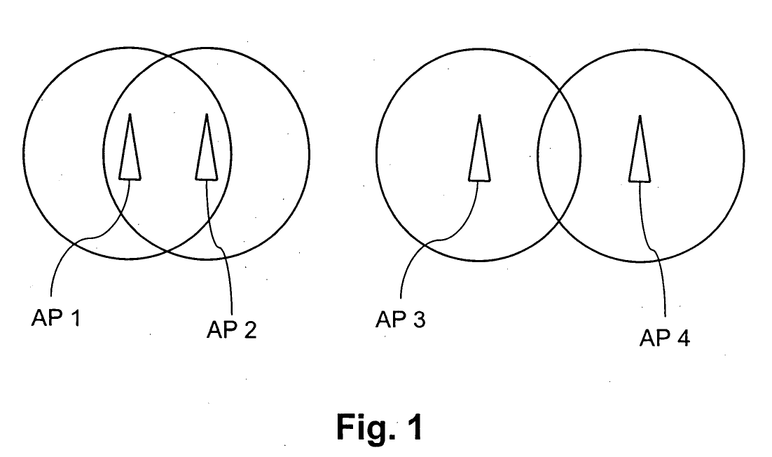

FIG. 2 is a schematic diagram showing a wireless network according to an embodiment of the invention.

### DESCRIPTION OF THE PREFERRED EMBODIMENT

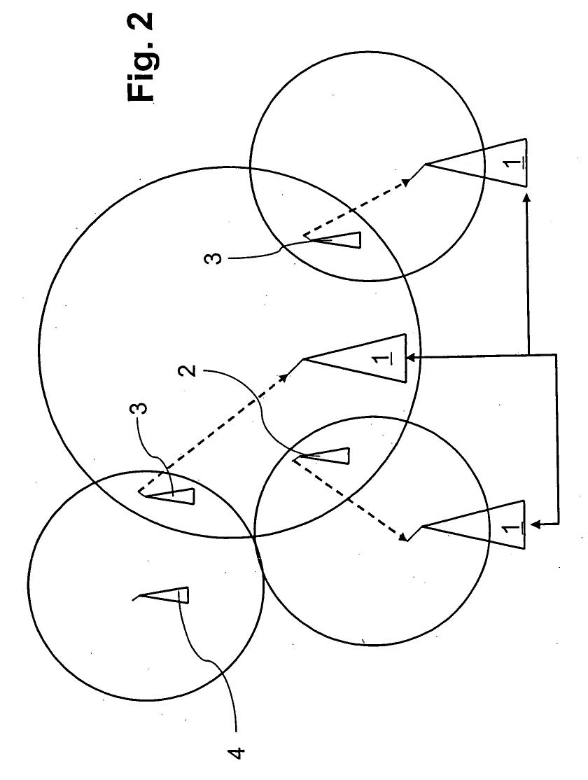

FIG. 2 shows a schematic example of an embodiment of a network according to the invention with a total of three access points 1. Furthermore, to give an example, in FIG. 2, a“regular” client station 2 as well as two mobile measurement stations 3 are depicted. Again, the circles indicate the respective coverage areas.

The solid lines indicate that the connection is realized as an Ethernet, by which the access points 1 of the network communicate with each other and auto-configure themselves in a decentralized manner by exchanging information. The dashed lines illustrate the transmission of additional information that the client station 2 and the measurement stations 3 send to the access points 1. This information can be received by the access points 1 with special antennas and serve the access points 1 as an additional input on which the configuration decision to be made by access point 1 can be based.

The measurement stations 3 are realized as mobile stations, so they can move within the network. In the scenario as depicted in FIG. 2, a disturbing station 4 has been detected which tries to manipulate the network. One of the measurement stations 3 has come near station 4 and sends important information, for example, about the kind of manipulation, the impacted channels, etc., to one of the access points 1. Via the Ethernet, the information is forwarded to the rest of the access points 1 and can consequently serve as base for changes in the network configuration to be done, in order to eliminate the disturbance by these means as much as possible.

Finally, it is particularly important to point out that the completely arbitrarily chosen examples of an embodiment of the teaching according to the invention form above only serve as illustration of the teaching as according to the invention, but that they do by no means restrict the latter to the given examples of an embodiment.

1. A network comprising:
an arbitrary number of access points; and
a multitude of client stations,
wherein the access points of the network communicate with each other and auto-configure themselves in a decentralized manner by exchanging information.

2. The network according to claim 1, wherein the network is a wireless network.

3. The network according to claim 1, wherein client stations are mobile stations.

4. The network according to claim 1, wherein the auto-configuration of the access points refers to the assignment of channels, the setting of signal strengths and security parameters, the determination of those client stations that are permitted access and the like.

5. The network according to claim 1, wherein the communication of the access points between each other is performed via a protocol that supports the exchange of environmental parameters, in particular, information regarding the use of channels by the access points of the network or by other networks.

6. The network according to claim 5, wherein the protocol supports the access points with respect to the mutual agreement on specific configurations.

7. The network according to claim 1, wherein the communication of the access points with each other is performed via a network that interconnects the access points.

8. The network according to claim 7, wherein the network that interconnects the access points is a local area network (LAN).

9. The network according to claim 1, wherein the access points adapt automatically on the base of the mutually exchanged information to changed conditions within the network.

10. The network according to claim 1, wherein information contributed by the client stations of the network have impact on the auto-configuration decisions of the access points.

11. The network according to claim 10, wherein the information contributed by the client stations of the network can be made directly available to the access points.

12. The network according to claim 10, wherein the client stations have equipment for position sensing and that the information contributed by the client stations of the network are usable for the access points to detect a local network topology.

13. The network according to claim 12, wherein the equipment for position sensing is GPS (Global Positioning System).

14. The network according to claim 1, wherein measurement stations provide network-specific information in order to support the auto-configuration process of the access points.

15. The network according to claim 14, wherein the measurement stations are positioned statically within the network.

16. The network according to claim 14, wherein the measurement stations are designed in a mobile way within the network.

17. The network according to claim 16, wherein the mobility of the measurement stations can be provided manually by an administrator or by a robot.

18. The network according to claim 17, wherein the access points instruct the robots regarding their directions of movement and/or targets.

19. A method for configuring a network, wherein the network comprises an arbitrary number of access points and a multitude of client stations, wherein the access points of the network communicate with each other and auto-configure themselves in a decentralized manner by exchanging information.

20. The method according to claim 19, wherein the network is a wireless network.

21. The method according to claim 20, wherein client stations are mobile stations.

22. The method according to claim 19, wherein the auto-configuration of the access points refers to the assignment of channels, the setting of signal strengths and security parameters, the determination of those client stations that are permitted access and the like.

23. The method according to claim 19, wherein the communication of the access points between each other is performed via a protocol which supports the exchange of environmental parameters, in particular, information regarding the use of channels by the access points of the network or by other networks.

24. The method according to claim 23, wherein the protocol supports the access points with respect to the mutual agreement on specific configurations.

25. The method according to claim 19, wherein the communication of the access points with each other is performed via a network that interconnects the access points.

26. The method according to claim 25, wherein the network that interconnects the access points is a local area network (LAN).

27. The method according to claim 19, wherein the access points adapt automatically on the base of the mutually exchanged information to changed conditions within the network.

28. The method according to claim 19, wherein information contributed by the client stations of the network have impact on the auto-configuration decisions of the access points.

29. The method according to claim 28, wherein the information contributed by the client stations of the network can be made directly available to the access points.

30. The method according to claim 28, wherein the client stations have equipment for position sensing and that the information contributed by the client stations of the network are used by the access points to detect a local network topology.

31. The method according to claim 30, wherein the equipment for position sensing is GPS (Global Positioning System).

32. The method according to claim 19, wherein measurement stations provide network-specific information in order to support the auto-configuration process of the access points.

33. The method according to claim 32, wherein the measurement stations are positioned statically within the network.

34. The method according to claim 32, wherein the measurement stations are designed in a mobile way within the network.

35. The method according to claim 34, wherein the mobility of the measurement stations can be provided manually by an administrator or by a robot.

36. The method according to claim 35, wherein the robots are instructed by the access points regarding their directions of movement and/or targets.

37. The network according to claim 11, wherein the client stations have equipment for position sensing and that the information contributed by the client stations of the network are usable for the access points to detect a local network topology.
